(19) United States
(12) Patent Application Publication
(10) Pub. No.: US 2020/0093337 A1
(43) Pub. Date: Mar. 26, 2020

(54) Assistive Apparatus With Buttocks Spreading Mechanism

(71) Applicant: Brian Schwab, Each Chatham, NY (US)

(72) Inventors: Brian Schwab, Each Chatham, NY (US); Cheng-Yang Lai, Taipei City (TW)

(73) Assignee: Brian Schwab, Each Chatham, NY (US)

(21) Appl. No.: 16/581,745

(22) Filed: Sep. 24, 2019

Related U.S. Application Data
(60) Provisional application No. 62/735,815, filed on Sep. 24, 2018.

(51) Int. Cl. A47K 13/10; A61G 15/00; A61G 15/12

(52) U.S. Cl. CPC A47K 13/10; A61G 15/12; A61G 15/007

(57) ABSTRACT

An assistive apparatus with a buttock-spreading mechanism suitable for assisting a person in getting onto a toilet is disclosed. The person using the toilet together with the assistive apparatus is able to transfer the bodyweight of the person to be supported by the assistive apparatus, thereby avoiding the transfer or distribution of the person's heavy weight directly to the toilet itself. The buttock-spreading mechanism includes expandable leaflets disposed on a platform to comfortably accommodates the dimensions of the person's buttocks, and the leaflets of the buttock-spreading mechanism is designed to be movable (e.g., expanded or retracted) for spreading the buttocks of the person.

### CROSS-REFERENCES TO RELATED APPLICATIONS

This application claims priority from U.S. Provisional Application Ser. No. 62/735,815 filed Sep. 24, 2018, which is hereby incorporated herein by reference in the respective in its entirety.

### BACKGROUND OF THE INVENTION

Embodiments of the present invention generally relate to apparatus for an assistive apparatus with buttocks spreading mechanism and expandable seat leaflets.

### Description of the Related Art

Conventionally, the size and shapes of a toilet seat is fixed without capacity of adjusting the width of the toilet seat as desired or customized per use. People with specific needs, such as bariatric, disable, and senior, who have difficulty in spreading their buttocks when such individual uses conventional toilets.

Therefore, an expandable assistive toilet seat apparatus is desirable so as to be placed on a toilet when an individual uses the toilet.

### SUMMARY OF THE INVENTION

The present invention generally an assistive apparatus and a method of using the assistive apparatus. The assistive apparatus includes an assistive platform having a centered opening, one or more actuators positioned within a leaflet support housing, a right leaflet being positioned on a top side of the assistive platform and connected to the one or more actuators within the leaflet support housing, and a left leaflet being positioned on the top side of the assistive platform and connected to the one or more actuators within the leaflet support housing. The one or more actuators are adapted to adjust a horizontal distance (“H”) between the left leaflet and the right leaflet to be apart, where the horizontal distance (“H”) is adjustable between a first horizontal distance (“H₁”) and a second horizontal distance (“H₂”).

In one embodiment, the one or more actuators are connected to one or more drive mechanisms and adapted to be rotated counterclockwise so as to move the right leaflet and the left leaflet in a direction L₁, and be rotated clockwise so as to move the right leaflet and the left leaflet in a direction L₂. In another embodiment, the one or more actuators comprises one or more ball screw linear actuators.

In still another embodiment, the assistive apparatus further includes one or more front supporting legs connected to the assistive platform. In one aspect, the one or more front supporting legs are substantially vertical and physically connected to one or more floor mounting flanges to secure the assistive apparatus and prevent movement. In another aspect, the one or more front supporting legs are connected to a front bar via one or more connectors.

In yet another embodiment, the assistive apparatus further includes one or more back supporting legs, being connected to a support frame mounting base, where the support frame mounting base is adapted to support the assistive platform. In one aspect, the one or more back supporting legs are substantially vertical and physically connected to one or more floor mounting flanges to secure the assistive apparatus and prevent movement.

In a further embodiment, the assistive apparatus further includes a lifting assembly being connected to the assistive platform, where the lifting assembly includes one or more lifting shafts adapted to lift the assistive platform so as to position the assistive platform to be tilted between a first stationery position to a second tilted position, tiled horizontally at an angle (“α”). In one aspect, the “α” angle is adjusted to be between 0° and 80°. In another aspect, the lifting assembly further includes one or more ball screw linear actuators, and one or more nuts connected to the one or more lifting shafts.

In another embodiment, the assistive apparatus further includes a controller being adapted to control the one or more actuators to adjust the horizontal distance (“H”) between the left leaflet and the right leaflet move the right. In one aspect, the controller is clipped on one or more grab handles, where the one or more grab handles are connected to the assistive platform and adapted to provide support to a person while the person is using the assistive apparatus. In another aspect, the controller includes a charging slot for charging the controller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. The drawings are not necessarily to scale. The drawings are merely schematic representations, not intended to portray specific parameters of the invention.

FIG. 1 is a perspective view of one example of an assistive apparatus having a buttock-spreading mechanism adapted to be positioned in a horizontal position according to one embodiment of the invention.

FIG. 2 is a perspective view of another example of an assistive apparatus mounted on top of an exemplary toilet according to one embodiment of the invention.

FIG. 3 is a perspective view of the assistive apparatus of FIG. 2, where the buttock-spreading mechanism is adapted to be positioned in an elevated position according to an embodiment of the invention.

FIG. 4 is a perspective view of one example of a top portion of a buttock-spreading mechanism having two adjustable leaflets according to another embodiment of the invention.

FIG. 5 is a perspective view of operating a buttock-spreading mechanism to adjust and expand a distance between the two leaflets according to still another embodiment of the invention.

FIG. 6 is a perspective view of one example of rotating an actuator for adjusting the location of a leaflet of a buttock-spreading mechanism according to yet another embodiment of the invention.

FIG. 7 is a perspective view of another example of rotating an actuator for adjusting the location of a leaflet of a buttock-spreading mechanism according to another embodiment of the invention.

FIG. 8 is a top view of operating exemplary drive mechanisms of a buttock-spreading mechanism to move and adjust the positions of two leaflets according to another embodiment of the invention.

FIG. 9 is a top view of an assistive platform of a buttock-spreading mechanism according to another embodiment of the invention.

FIG. 10 is a top view of a buttock-spreading being positioned on top of a support frame mounting base mechanism in a pre-set position, showing two leaflets being spaced apart at a horizontal distance (e.g., at a H₂ distance) and mounted on an assistive platform according to another embodiment of the invention shown in a retracted mode.

FIG. 11 is a side view of a person's buttocks sitting on top of two leaflets positioned in a pre-set position, where the right and left leaflets are spaced at a horizontal distance (e.g., at a H₂ distance) according to another embodiment of the invention.

FIG. 12 is a top view of a buttock-spreading being positioned on top of a support frame mounting base mechanism in an expanded position, showing two leaflets being adjusted to be apart at a horizontal distance (e.g., at a H₁ distance) according to another embodiment of the invention.

FIG. 13 is a side view of a person's buttocks sitting on top of two leaflets adjusted to be in an expanded position, where the right and left leaflets are spaced at a horizontal distance (e.g., at a H₁ distance) according to another embodiment of the invention.

FIG. 14 is a perspective view of a backrest assembly mounted on a support frame mounting base on top of two back supporting legs according to another embodiment of the invention.

FIG. 15 is a side view of an assistive apparatus, showing the buttock-spreading mechanism in an elevated position according to an embodiment of the invention.

FIG. 16 is a side view of an assistive apparatus, showing the buttock-spreading mechanism in a horizontal position according to one embodiment of the invention.

FIG. 17 is a perspective view of an exemplary controller according to another embodiment of the invention.

FIG. 18 is a bottom perspective view of another exemplary controller according to another embodiment of the invention.

FIG. 19 is a flowchart of a method of operating an assistive apparatus having a buttock-spreading mechanism according to another embodiment of the invention.

### DETAILED DESCRIPTION

The present invention includes an assistive apparatus with a buttock-spreading mechanism for providing weight support as well as spreading a person's buttocks while using a toilet. The apparatus can be placed directly over a rim of a toilet bowl, a seat of a toilet seat system, a shower chair or a bedside commode. The buttock-spreading mechanism of the assistive apparatus as described in detail below can accommodates different personal sizes (different distances between different persons' buttocks). When an individual person uses a toilet coupled with the assistive apparatus with the buttock-spreading mechanism described herein, the weight of the individual person can be supported, not only by the toilet but also the assistive apparatus of the current invention, thereby avoiding distribution of all weights of the individual person to the toilet itself.

In addition, the assistive apparatus equipped with an expandable buttock spreading mechanism is designed to be placed on any kinds of a toilet, any shower chairs, or other devices such that when a person uses the toilet the weight of the person is transferred from the toilets to the assistive apparatus, avoiding distribution of all of the person's weight directly to the toilet itself.

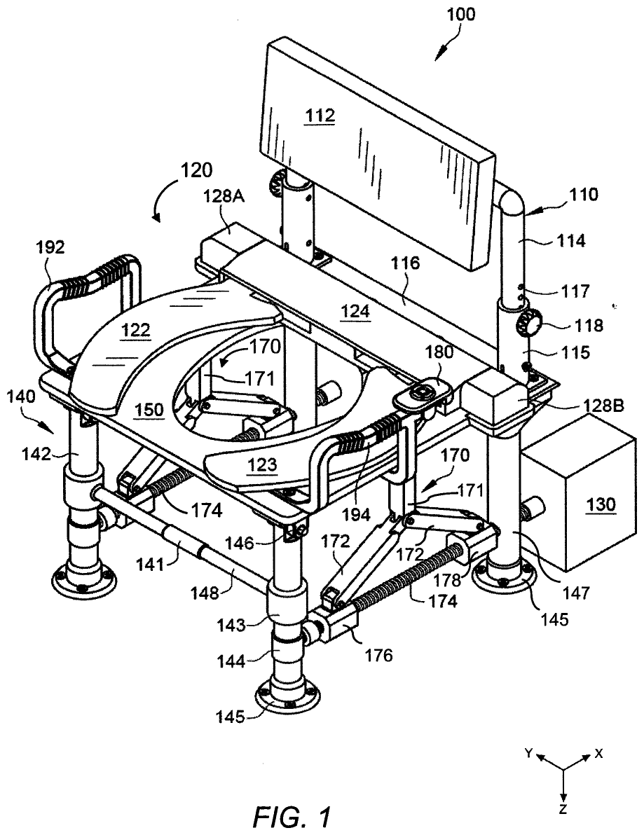

FIG. 1 illustrates a perspective view of one example of an assistive apparatus 100, which generally includes a buttock-spreading mechanism 120, a supporting leg mechanism 140, and a lifting mechanism 170. An individual person can operate the assistive apparatus 100 for sitting down on top of the assistive apparatus 100 and operating a controller 180. For example, a person may sit on top of the assistive apparatus with the help of two or more armrests (e.g., grab handles 192, 194 being attached to the assistive platform 150 of the assistive apparatus 100), and control the assistive apparatus using the controller 180. The controller 180 can be a wireless remote control or a wired controller. As an example, the controller 180 can be easily mounted and coupled to one of the grab handles 192, 194 for easy access and personal use.

The assistive apparatus 100 can also include a power unit 130, being positioned, for example, adjacent the supporting leg mechanism 140 or near the base of a toilet. The power unit 130 may contain internal electric circuits and one or more motors therein for providing powers and control circuits for operating the assistive apparatus 100.

In one embodiment, the buttock-spreading mechanism 120 includes a right leaflet 122 and a left leaflet 123 connected to a leaflet support base 124, which is mounted on a top side of an assistive platform 150. The leaflet support base 124 includes a housing with one or more opening on one side for the right leaflet 122 and the left leaflet 123 connected thereto to be adjustably moving around by having at least one drive mechanism (e.g., drive mechanisms 128A, 1288, etc.) coupled or attached to the leaflet support base 124. In addition, one or more actuators are positioned within the housing of the leaflet support base 124 and connected to the right leaflet 122 and the left leaflet 123 for moving the right leaflet 122 and the left leaflet 123 connected thereto.

The supporting leg mechanism 140 is adapted to support the assistive platform 150 and includes two or more front supporting legs 142. In some embodiment, the supporting leg mechanism 140 may optionally include two or more back supporting legs 147. In one embodiment, the front supporting legs 142 and/or the back supporting legs 147 can be secured on a platform or to the ground (e.g., via one or more floor mounting flange 145 at the bottom ends of the front supporting legs 142 and/or the back supporting legs 147) for supporting the weight of the assistive apparatus 100 and a person who may sit on top of the assistive apparatus 100. Because of the strong structural support of the assistive apparatus, a suitable person's weight to be supported by the assistive apparatus 100 may be a very large range of between 30 pounds and 300 pounds or larger, such as 100 pounds or larger, or 200 pounds or larger, etc.

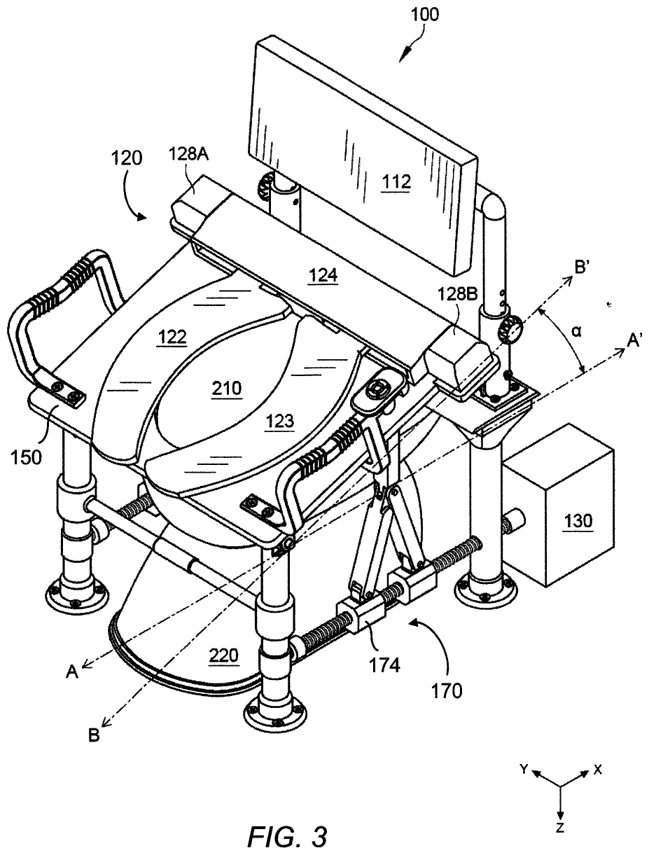

Each of the front supporting legs 142 and the back supporting legs 147 is substantially vertical and may be physically joined to a floor mounting flange (e.g., the floor mounting flange 145). The floor mounting flange 145 is secured with four floor mounting bolts to prevent movement and ensure a stable foundation. Also, a connector 143 can be coupled to each of the front supporting legs 140 to join to a front bar 148, which may be optionally jointed to a frame connector 141 to prevent horizontal movement and vibration. The two front supporting legs 140 connect to the assistive platform 150 via a hinge 146. This feature allows the assistive platform 150 to be able to be tilt forward at an approximate angle of α° (as shown in FIG. 3).

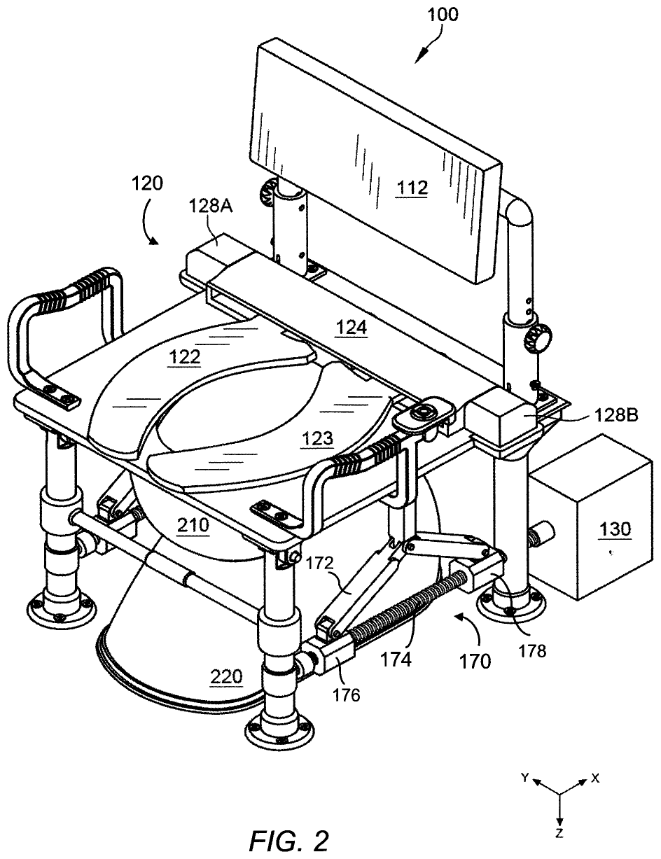

Two or more lifting mechanisms (e.g., a lifting mechanism 170) are positioned on the both sides of the buttock-spreading mechanism 120 and provided to support and lift the buttock-spreading mechanism 120 from a horizontal position (e.g., as shown in FIGS. 1 and 2. To an elevated position (e.g., as shown in FIG. 3). The lifting mechanism 170 may include one or more arms and/or lifting shafts (e.g., a lifting shaft 171 and one or lifting shafts 172 coupled together to be operated by an actuator assembly for lifting the buttock-spreading mechanism 120 by raising the assistive platform 150 between a horizontal position (e.g., the assistive platform 150 being positioned as shown in FIG. 2) and an elevated/angled position (e.g., the assistive platform 150 being positioned as shown in FIG. 3).

The actuator assembly of the lifting mechanism 170 may include a ball screw linear actuator 174 and one or more nuts 176, 178 connected to the lifting shafts 171, 172 and adapted to lift the assistive platform 150. The movement of the actuator assembly of the lift mechanism 170 is driven by the power unit 130. Optionally, the ball screw linear actuator 174 may be positioned between the front supporting legs 142 and the back supporting legs 147 in order to connect the front supporting legs 142 and the back supporting legs 147 (e.g., via one or more connectors 144) and provide structural support to the front supporting legs 142 and/or the back supporting legs 147.

In addition, the assistive apparatus 100 can optionally include a back support (e.g., a backrest assembly 110, etc.) suitable for a person sitting on top of the assistive apparatus 100 to rest his or her back thereon. The backrest assembly 110 can be mounted on top of a support frame mounting base 116, which is positioned on top of the back supporting legs 147. The backrest assembly 110 on top of the support frame mounting base 116 may include a top support frame 114 and a bottom support frame 115, which are connected together by one or more fastening elements (e.g., one or more fastening knob 118). One or more holes 117 are located on the top support frame 114 and/or the bottom support frame 115. In one embodiment, the height of the backrest assembly 110 is adjustable, for example, by adjusting the connection of the top support frame 114 and the bottom support frame 115 via the adjustment of the positions of the holes 117 coupled to the fastening knobs 118). The backrest assembly 110 may also include a back rest pad 112, which can be a cushioned support for providing comfort and back support to the person sitting on top of the assistive apparatus 100.

FIG. 2 illustrate an exemplary assistive apparatus being mounted on top of an exemplary toilet where the buttock-spreading mechanism 120 is lowered in a horizontal position according to one embodiment of the invention. In the example of FIG. 2, the assistive apparatus 100 can be attached to a toilet having a toilet base 220 and a toilet bowl 210. In another example, the toilet can be any of a conventional toilet, commonly found in residential, commercial, and institutional environments. In this position, the assistive platform 150 is adapted to touch and rest on top of the support frame mounting base 116.

FIG. 3 is a perspective view of the assistive apparatus of FIG. 2, where the buttock-spreading mechanism 120 is adapted to be positioned in an elevated position on top of the toilet bowel 210. For example, the buttock-spreading mechanism 120 can be elevated by the lifting mechanism 170 attached to both sides of the assistive platform 150 of the assistive apparatus 100. The lifting mechanism 170 is adapted to lift the assistive platform 150, where one or more ball screw linear actuators 174 of the lifting mechanism 170 are adapted to expand and contract, thereby driving the lifting shafts 171, 172 up and down so as to adjust the height of the assistive platform 150 and the buttock spreading mechanism 120 thereon to an desirable elevated position. Thus, the assistive platform 150, when being lifted to an elevated position, is adapted to be away from the support frame mounting base 116 such that a line A-A′ (defined as from a top end of the front supporting leg 142 to a top end of the back supporting leg 147) and a line B-B′ (defined as from a top end of the front supporting leg 142 to a bottom end of the assistive platform 150) is crossed at an angle “α”.

In one embodiment, as shown in FIG. 3, the buttock-spreading mechanism 120 can be positioned in an elevated position elevated at an angle “α”. In another embodiment, the buttock-spreading mechanism 120 can be positioned on top of the toilet bowel 210 in a horizontal position (as shown in FIG. 2, where the angle “α” equals to zero (0)).

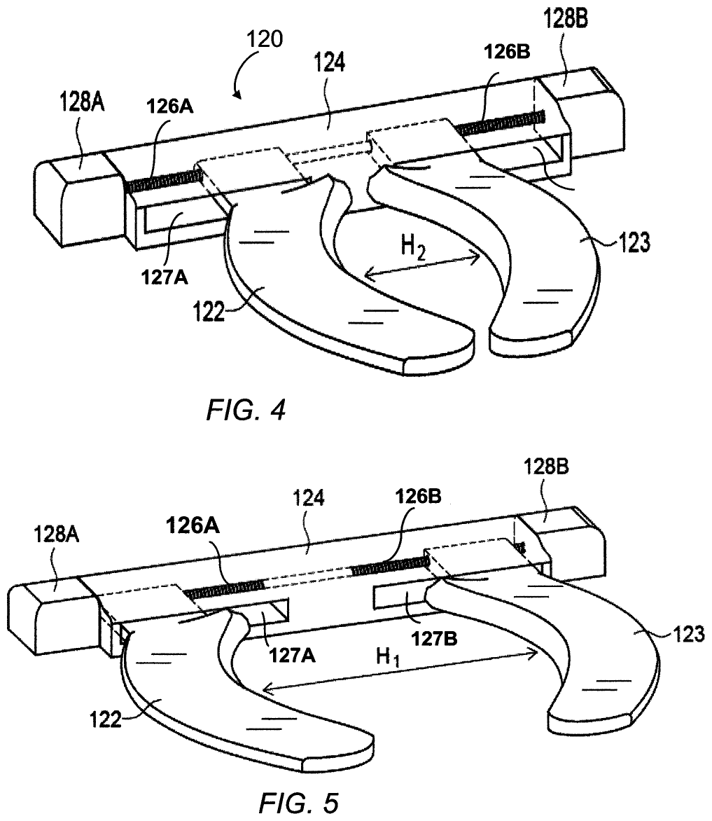

FIG. 4 and FIG. 5 illustrate one example of a top portion of the buttock-spreading mechanism 120 of the assistive apparatus 100, where the right leaflet 122 and the left leaflet 123 are adapted to be moved and operated in a contracted position and an expanded position, respectively. As shown in FIGS. 4-5, the right leaflet 122 and the left leaflet 123 are connected to an actuator 126A and an actuator 126B, respectively, inside the housing of the leaflet support base 124 via one or more openings 127A, 127B. A horizontal distance (“H”) between the right leaflet 122 and the left leaflet 123 can be adjustable via one or more drive mechanisms 128A, 128B positioned around the leaflet support base 124, e.g., on both sides of the leaflet support base 124. The one or more drive mechanisms 128A, 1288 can be connected to one or more actuators 126A, 1268 for driving and positioning the right leaflet 122 and the left leaflet 123, respectively.

The right leaflet 122 and the left leaflet 123 are positioned on a top side of the assistive platform 155 and connected to one or more actuators (e.g. the actuators 126A, 1268) positioned within the leaflet support housing 124. For example, the positions of the right leaflet 122 and the left leaflet 123 can be adjusted by the actuators 126A, 1268 and the drive mechanisms 128A, 1288 such that a horizontal distance between the mid portions of the right leaflet 122 and the left leaflet 123 is adjustably to between a first horizontal distance (“H₁”), as shown in FIG. 5, and a second horizontal distance (“H₂”), as shown in FIG. 4.

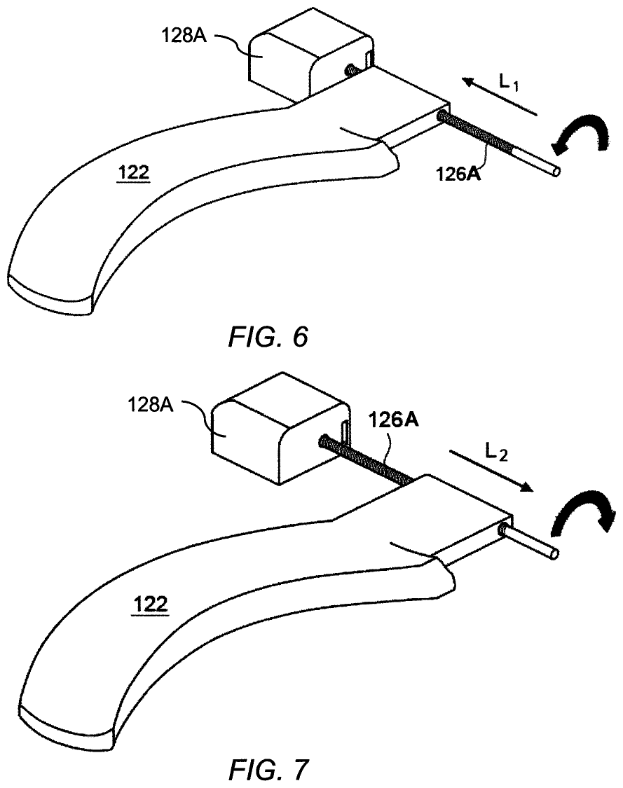

In one embodiment, the one or more actuators 126A, 1268 of the buttock-spreading mechanism 120 are adapted to adjust a horizontal distance (“H”) between the right leaflet 122 and the left leaflet 123 from the second horizontal distance (“H₂”) to the first horizontal distance (“H₁”), thereby spreading the buttocks of a person sitting on top of the buttock-spreading mechanism 120. FIG. 6 illustrate an example for operating the drive mechanism 128A and the actuator 126A in a counterclockwise direction in order to move the right leaflet 122 in an L₁ direction for spreading the buttocks of a person and expanding the right leaflet 122 to an expanded position.

In another embodiment, the one or more actuators 126A, 126B of the buttock-spreading mechanism 120 are adapted to adjust a horizontal distance (“H”) between the right leaflet 122 and the left leaflet 123 from a first horizontal distance (“H₁”) to a second horizontal distance (“H₂”), thereby retracting the buttocks of a person sitting on top of the buttock-spreading mechanism 120. FIG. 7 illustrate an example for operating the drive mechanism 128A and the actuator 126A in a clockwise direction in order to move the right leaflet 122 in an L₂ direction for retracting the buttocks of a person and returning the right leaflet 122 to a contacted position.

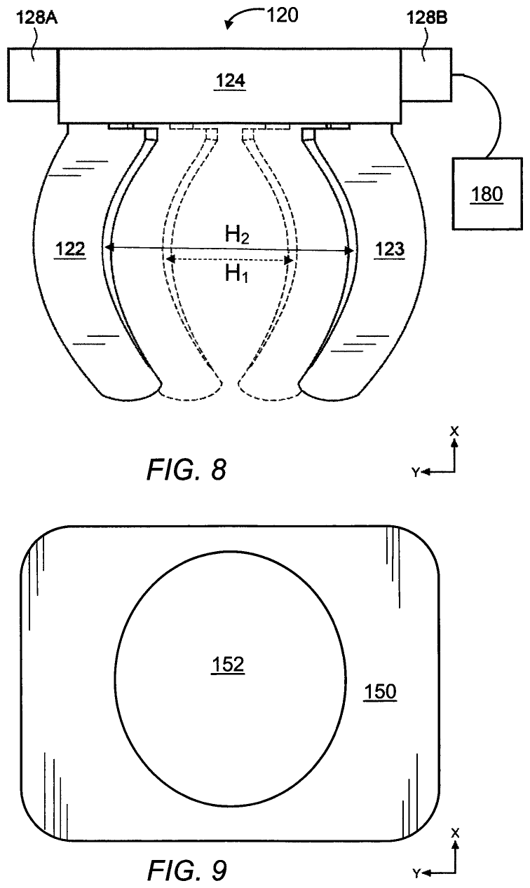

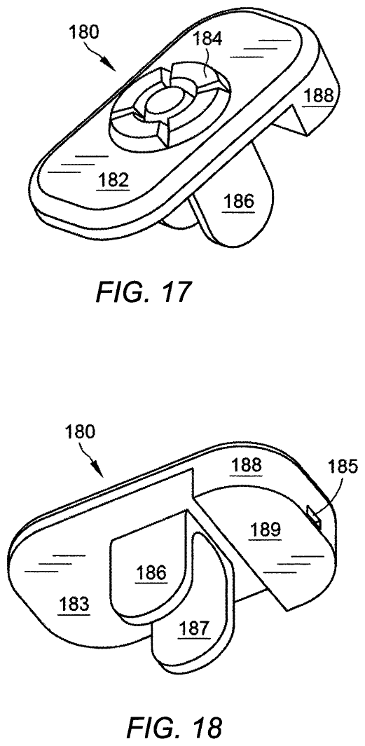

FIG. 8 is a top view of the buttock-spreading mechanism 120 and illustrates examples for the movements of the right leaflet 122 and the left leaflet 123. As shown in FIG. 8, a controller 180 can be used to control the drive mechanisms 128A, 1288 as well as the actuators 126A, 1268 (not shown) inside the leaflet support base 124 to move the right leaflet 122 and the left leaflet 123. One example of the controller 180 may be a control with several control buttons (e.g., an exemplary controller as shown FIGS. 17 and 18).

FIG. 9 illustrate one example of the assistive platform 150 of the buttock-spreading mechanism 120 without showing the leaflet support base 124, the right leaflet 122 or the left leaflet 123. In the example of the assistive platform 150 as shown in FIG. 9, the assistive platform 150 may contain an opening 152, which is preferably being centered and aligned with a centered space between the right leaflet 122 and the left leaflet 123. The shapes and sizes of the opening 152 of the assistive platform 150 are not limiting and can be any of oval, circular, rectangular shapes, etc.

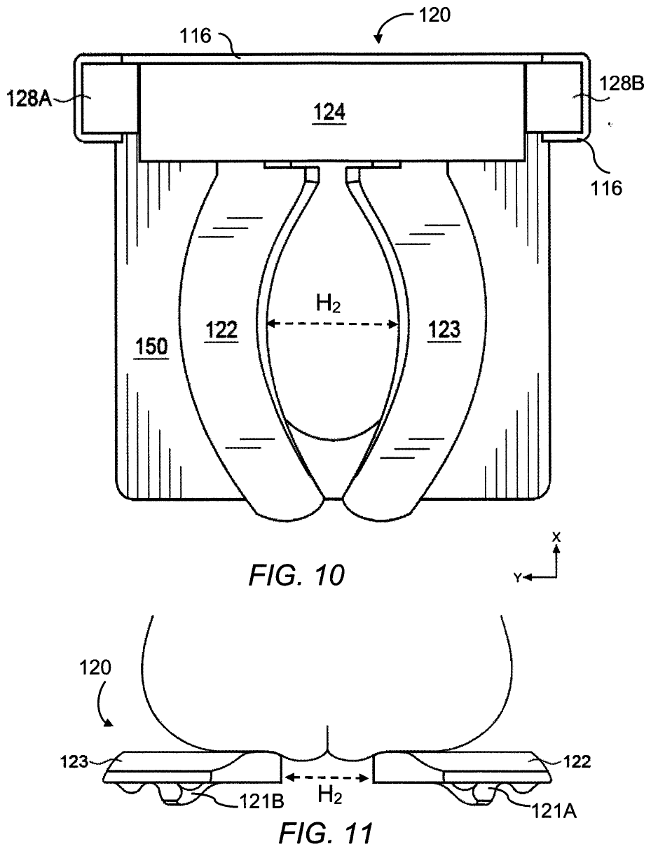

FIGS. 10-13 illustrates top views and side views of the buttock-spreading mechanism 120 of the assistive apparatus 100 and show that the positions of the right leaflet 122 and the left leaflet 123 are capable of being spaced apart and expandable from a centered position to an expanded position in order to spread a right buttock and/or a left buttock of an individual person while he or she is sitting on top of the assistive apparatus comfortably.

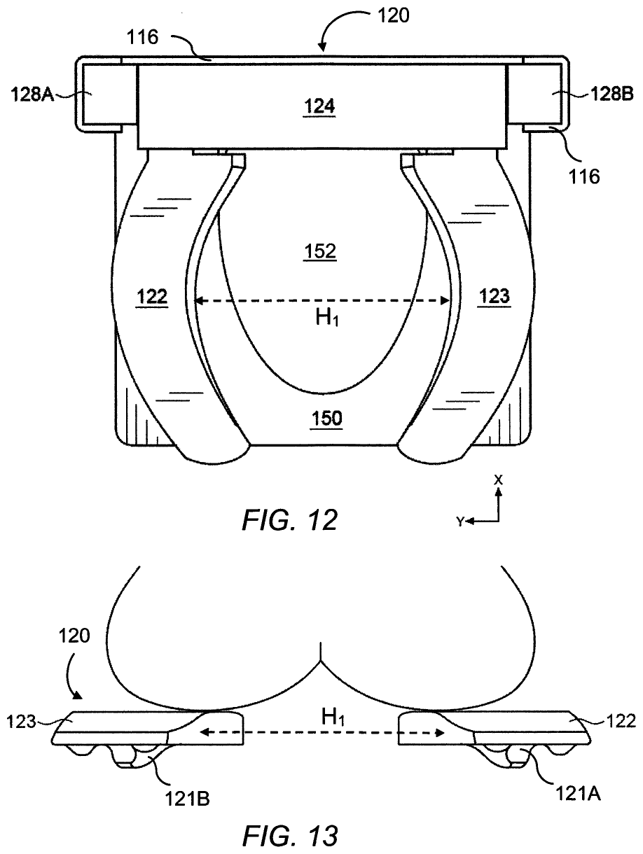

In FIGS. 10-11, showing top view and side view of the buttock-spreading mechanism 120, it is shown that the positions of the right leaflet 122 and the left leaflet 123 are in its centered position such that the horizontal distance (“H”) between the right leaflet 122 and the left leaflet 123 is in the second horizontal distance (“H₂”). In FIGS. 12-13, top view and side view of the buttock-spreading mechanism 120 are shown and the positions of the right leaflet 122 and the left leaflet 123 of the buttock-spreading mechanism 120 are in its expanded position such that the horizontal distance (“H”) between the right leaflet 122 and the left leaflet 123 is in the first horizontal distance (“H₁”) and a right buttock and/or a left buttock of an individual person sitting on top of the assistive apparatus can be comfortably spread and cleaned.

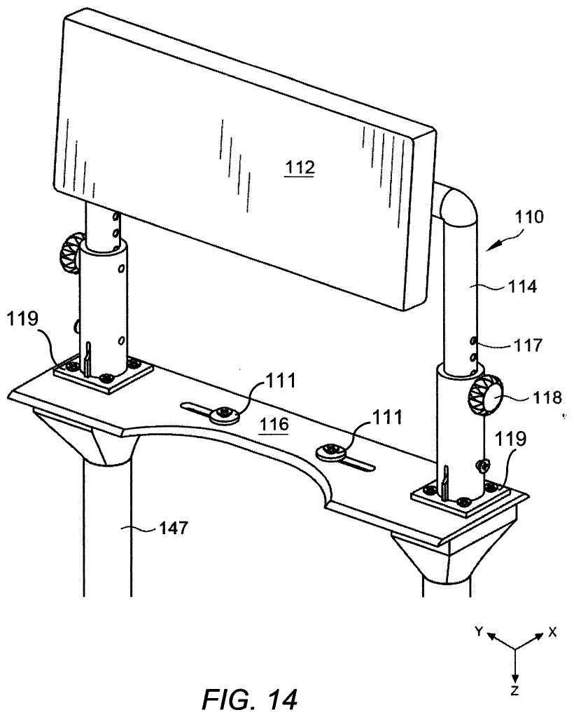

FIG. 14 is one example of the backrest assembly 110 being able to coupled to the assistive apparatus 100 of the invention. As shown in FIG. 14, the backrest assembly 110 may be secured to the support frame mounting base 116 via one or more mounting flanges 119 such that a person sitting on top of the assistive apparatus 100 is able to rest his or her back on the back rest pad 112 of the backrest assembly. The support frame mounting base 116 is generally positioned near the rear end of a toilet bowel, for example by securing with two mounting bolts 111 and can sometimes be further supported by a pair of the back supporting legs 147 attached thereto. Each back supporting leg 147 is preferably substantially vertical and physically secured to the ground (e.g., via the floor mounting flange 145 as shown in FIG. 1).

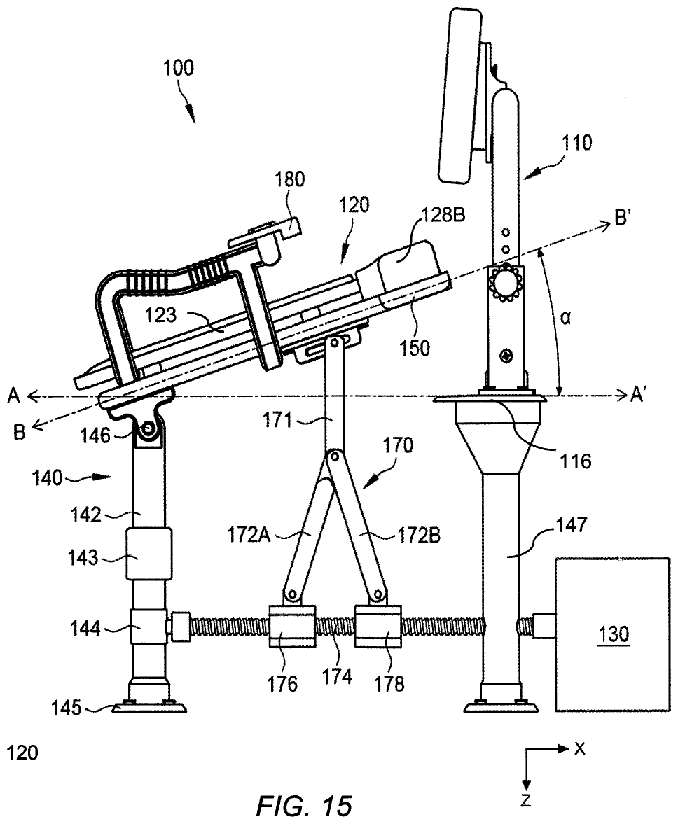

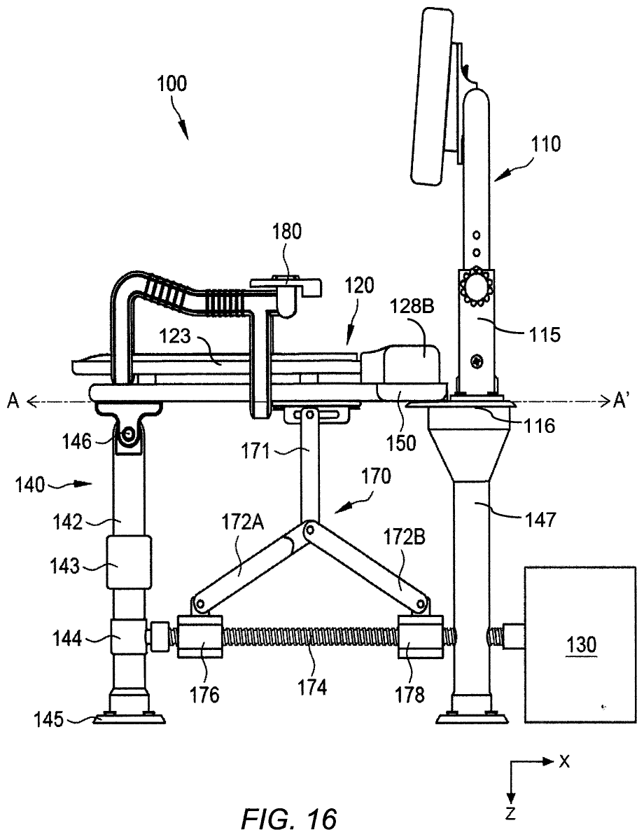

FIG. 15 shows one example of a side view of the assistive apparatus 100 of the example at FIG. 3, where the buttock-spreading mechanism 120 is in an elevated position, tilted at an angle “α” between line A-A′ and line B-B′. FIG. 16 shows one example of a side view of the assistive apparatus 100 at FIG. 1, where the buttock-spreading mechanism 120 is in a horizontal position, and the angle “α” equals to zero (horizontal line A-A′).

The lifting mechanism 170 is controlled by the controller 180, which in turn is adapted to control the power unit 130, to adjustably lift up (as shown in FIG. 15 in a lifted tilted position) or lower down (as shown in FIG. 16 in a lowered horizontal position). The power unit 130 is adapted to the rotate the ball screw linear actuators 174 in clockwise or counterclockwise directions such that the lifting shafts 172A, 172B are able to move its own locations, thereby moving the assistive platform 150 of the buttock-spreading mechanism 120, which is connected to the lifting shaft 171, which in turn is connected to the lifting shafts 172A, 172B, and lifting a person sitting on top of the buttock-spreading mechanism 120. To lift up the assistive platform 150, the power unit 130 rotates the ball screw linear actuator 174 to move the nuts 176, 178 from their spaced-apart position to their centered position. The top side of the lifting shafts 172 A, 172B are connected to the lifting shaft 171 to push the lifting shaft 171 up and generate an upward force to lift the assistive platform in a vertical direction to a higher position. To lower down the assistive platform 150, the power unit 130 rotates the ball screw linear actuator 174 (in an opposite direction as compared to lifting) so that the nuts 176, 178 are moved from their centered position to be spaced apart. The top side of the lifting shafts 172 A, 172B are thus lowered down in positions, thereby lowering down the assistive platform 150 in a vertical direction to a lower position.

FIGS. 17-18 illustrate one example of the controller 180 in its top perspective view and bottom perspective view, respectively, according to one or more embodiments of the invention. The controller 180 may include a top side 182, one or more bottom sides 188, 189, and one or more side surfaces 188. The top side 182 may include several control buttons, such as a control panel with 5-ways control button, e.g., control buttons 184 as shown in FIG. 17. The controller 180 may be a wired or wireless controller, optionally with a charging slot 185, which may serve as a charging port of the controller 180 for power supply. The controller 180 may be adapted to be clipped on one of the grab handles 192, 194, for example, by using one or more U shape connecting wings 186, 187.

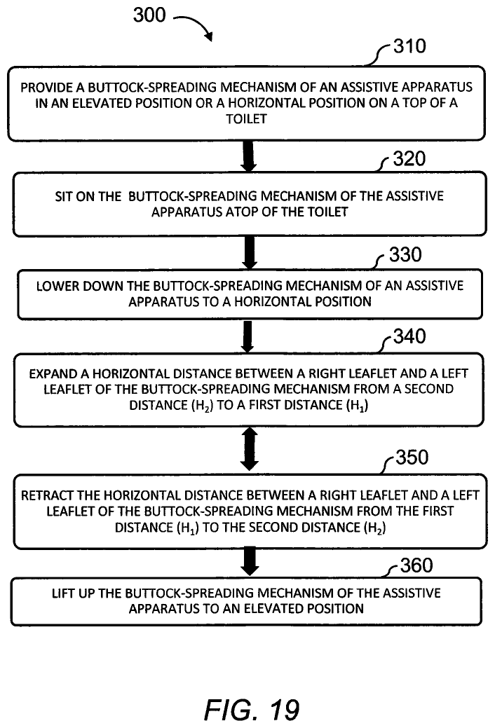

FIG. 19 is a flowchart of an example of a method 200 of operating an assistive apparatus having a buttock-spreading mechanism according to another embodiment of the invention. The method 300 includes a step 310 of initially providing a buttock-spreading mechanism of an assistive apparatus, such as the buttock-spreading mechanism 120 of the assistive apparatus 100 as described above, in an elevated position or a horizontal position on top of a toilet so that a person using the assistive apparatus is able to sit on the buttock-spreading mechanism a ton of the toilet at step 320.

At step 330, the person is able to lower down the buttock-spreading mechanism of the assistive apparatus from an initial position (e.g., an elevated position) to a horizontal position via a controller (e.g., the controller 180 connected to the assistive apparatus 100) and comfortably sit on the buttock-spreading mechanism of the assistive apparatus.

At step 340 and step 350, the person using the assistive apparatus is able to adjust the positions of the leaflets of the buttock-spreading mechanism, such as by expanding a horizontal distance between a right leaflet and a left leaflet of the buttock-spreading mechanism from a second distance (H₂) to a first distance (H₁), or retracting the horizontal distance between a right leaflet and a left leaflet of the buttock-spreading mechanism from the first distance (H₁) to the second distance (H₂).

Finally, at step 360, the person using the assistive apparatus is able to operate the assistive apparatus via the controller to lift up the buttock-spreading mechanism of the assistive apparatus to an elevated position to assist the person to get up easy. In addition, the person using the assistive apparatus is able to use the controller and adjust the positions of the leaflets of the assistive apparatus via the controller to a desirable position. For example, the person may use the controller to move the positions of the left and right leaflets to retract them back to a position when the buttock-spreading mechanism is at an initial elevated position.

While the foregoing is directed to embodiments of the present invention, other and further embodiments of the invention may be devised without departing from the basic scope thereof, and the scope thereof is determined by the claims that follow.

1. An assistive apparatus, comprising:
an assistive platform having a centered opening;
one or more actuators being positioned within a leaflet support housing;
a right leaflet being positioned on a top side of the assistive platform and connected to the one or more actuators within the leaflet support housing; and
a left leaflet being positioned on the top side of the assistive platform and connected to the one or more actuators within the leaflet support housing,
wherein the one or more actuators are adapted to adjust a horizontal distance (“H”) between the left leaflet and the right leaflet, wherein the horizontal distance (“H”) is adjustable between a first horizontal distance (“H₁”) and a second horizontal distance (“H₂”).

2. The assistive apparatus of claim 1, wherein the one or more actuators are connected to one or more drive mechanisms and adapted to be rotated counterclockwise so as to move the right leaflet and the left leaflet in a direction L₁, and be rotated clockwise so as to move the right leaflet and the left leaflet in a direction L₂.

3. The assistive apparatus of claim 1, wherein the one or more actuators comprises one or more ball screw linear actuators.

4. The assistive apparatus of claim 1, further comprising:
one or more front supporting legs connected to the assistive platform.

5. The assistive apparatus of claim 4, wherein the one or more front supporting legs are substantially vertical and physically connected to one or more floor mounting flanges to secure the assistive apparatus and prevent movement.

6. The assistive apparatus of claim 4, wherein the one or more front supporting legs are connected to a front bar via one or more connectors.

7. The assistive apparatus of claim 1, further comprising:
one or more back supporting legs, being connected to a support frame mounting base, wherein the support frame mounting base is adapted to support the assistive platform.

8. The assistive apparatus of claim 7, wherein the one or more back supporting legs are substantially vertical and physically connected to one or more floor mounting flanges to secure the assistive apparatus and prevent movement.

9. The assistive apparatus of claim 1, further comprising:
a lifting assembly being connected to the assistive platform, wherein the lifting assembly comprising one or more lifting shafts adapted to lift the assistive platform so as to position the assistive platform to be tilted between a first stationery Position to a second tilted position, tiled horizontally at an angle (“α”).

10. The assistive apparatus of claim 9, wherein the “α” angle is adjusted to be between 0° and 80°.

11. The assistive apparatus of claim 9, wherein the lifting assembly further comprises:
one or more ball screw linear actuators; and
one or more nuts connected to the one or more lifting shafts.

12. The assistive apparatus of claim 1, further comprising:
a controller being adapted to control the one or more actuators to adjust the horizontal distance (“H”) between the left leaflet and the right leaflet move the right.

13. The assistive apparatus of claim 12, wherein the controller is clipped on one or more grab handles, wherein the one or more grab handles are connected to the assistive platform and adapted to provide support to a person while the person is using the assistive apparatus.

14. The assistive apparatus of claim 12, wherein the controller comprises a charging slot for charging the controller.
